(19) United States
(12) Patent Application Publication
(10) Pub. No.: US 2007/0209743 A1
(43) Pub. Date: Sep. 13, 2007

(54) TIRE WITH REINFORCING EXO-BELT SKIN

(75) Inventor: Yann Mellet, Philadelphia, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(73) Assignee: SWEETSKINZ, INC., Bala Cynwyd, PA (US)

(21) Appl. No.: 11/680,212

(22) Filed: Feb. 28, 2007

Related U.S. Application Data
(63) Continuation-in-part of application No. 11/470,064, filed on Sep. 5, 2006.
(63) Continuation of application No. 10/253,837, filed on Sep. 24, 2002, now Pat. No. 7,118,643.
(60) Provisional application No. 60/325,523, filed on Sep. 28, 2001.

(51) Int. Cl. B60C 5/00

(52) U.S. Cl. 152/158

(57) ABSTRACT

A tire for mounting to a transport vehicle including a base tire and a skin. The skin includes a predetermined pattern mounted thereon that is positioned on an external peripheral surface of the skin. The base tire and the skin are constructed of a predetermined rubber composition. The skin includes at least about nine percent (9%) by weight of reinforcing fibers and the base tire includes less than about three percent (3%) by weight of reinforcing fibers. An adhesive membrane inhibitor is positioned between the base tire and the skin to generally prevent migration of contaminating materials from the base tire into the skin and, more particularly from the base tire into the predetermined pattern of the skin.

### CROSS-REFERENCE TO RELATED APPLICATIONS

This patent application is a continuation-in-part of U.S. patent application Ser. No. 11/470,064, filed Sep. 5, 2006, which is a continuation of U.S. patent application Ser. No. 10/253,837, now U.S. Pat. No. 7,118,643, filed Sep. 24, 2002, which claims the benefit of U.S. Provisional Patent Application No. 60/325,523, filed Sep. 28, 2001, the entire subject matters of which are hereby incorporated by reference.

### BACKGROUND OF THE INVENTION

The present invention relates generally to tire enhancement and, more particularly, to a tire having a reinforcing exo-belt cover or skin, having a relatively high percentage by weight of a reinforcing material covering an entire outer surface of a base tire, wherein the base tire generally does not include or includes a low percentage by weight of a reinforcing material therein. Tires typically include a uniform distribution of reinforcing material throughout with respect to the outer surface of the tire including the treads and the remaining portions of the base tire. It would be advantageous to construct a tire having a concentration of reinforcing material at its outer surface, including on the treads and at the root of the treads where the tire is subjected to high stresses and impact loads.

### BRIEF SUMMARY OF THE INVENTION

Briefly stated, in a preferred embodiment, the present invention is directed to a tire for mounting to a transport vehicle including a base tire and a skin. The skin includes a predetermined pattern mounted thereon that is positioned on an external peripheral surface of the skin. The base tire and the skin are constructed of a predetermined rubber composition. The skin includes at least about nine percent (9%) by weight of reinforcing fibers and the base tire includes less than about three percent (3%) by weight of reinforcing fibers.

In another aspect, the prevent invention is directed to a tire for mounting to a transportation vehicle including a base tire constructed of a first rubber mixture and a skin constructed of a second rubber mixture. The first rubber mixture includes about less than three percent (3%) by weight reinforcing fibers and the second rubber mixture includes about nine percent (9%) or more reinforcing fibers by weight. The skin is mounted to and covers an entire outer circumferential surface of the base tire.

In a further aspect, the present invention is direct to a tire assembly for insertion into a mold for construction of a tire. The tire assembly includes a partially cured base tire, an adhesive membrane inhibitor and a partially cured skin. The adhesive membrane inhibitor is positioned on an outer circumferential surface of the partially cured base tire and the partially cured skin is positioned on the adhesive membrane inhibitor. The partially cured skin includes a predetermined pattern printed thereon. The predetermined pattern is positioned on an external peripheral surface of the skin. The adhesive membrane inhibitor generally prevents migration of contaminating materials between the base tire and skin during curing.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a side perspective view of a cover or skin for a tire in accordance with a first preferred embodiment of the present invention;

FIG. 2 is an enlarged side perspective view of a portion of a bicycle tire showing the skin of FIG. 1 applied thereto;

FIG. 2A is a cross-sectional view of the bicycle tire shown in FIG. 2, taken along line 2A-2A of FIG. 2;

FIG. 3 is a fragmentary top plan view of a skin for a tire in accordance with a second preferred embodiment of the present invention;

FIG. 4 is a fragmentary top plan view of a portion of a partially cured base tire in accordance with a first preferred embodiment of the present invention;

FIG. 5 is a cross-sectional view of a partially cured bicycle tire illustrating the initial stage of application of the skin of FIG. 3 and an adhesive membrane inhibitor to the partially cured base tire of FIG. 4; and

FIG. 6 is a cross-sectional view of a bicycle tire of the first preferred embodiment mounted to a rim with the skin of FIG. 3 applied thereto.

### DETAILED DESCRIPTION OF THE INVENTION

Certain terminology is used in the following description for convenience only and is not limiting. The words “right”, “left”, “lower” and “upper” designate directions in the drawings to which reference is made. The words “inwardly” and “outwardly” refer to directions toward and away from, respectively, the geometric center of the bicycle tire and designated parts thereof. The terminology includes the above-listed words, derivatives thereof and words of similar import.

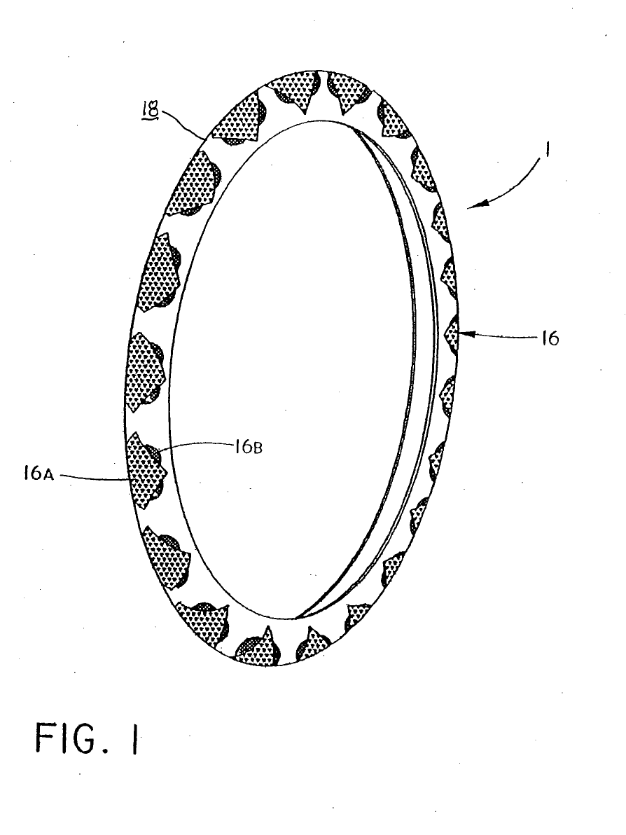

Referring to the drawings in detail, wherein like numerals indicate like elements throughout, there is shown in FIGS. 1-6, preferred embodiments of a bicycle tire with a reinforcing exo-belt skin 1 including a relatively high percentage by weight of a reinforcing fiber therein to provide strength and durability to the tire. Although the exemplary embodiment of the present application is specifically directed to a bicycle tire, the use of the reinforcing exo-belt skin 1 is not limited to bicycle tires and may be constructed and adapted for use with nearly any type of tire, for example, automobile tires, motorcycle tires, mope tires, wheelbarrow tires and other like tires that are utilized for a variety of vehicles or transportation mechanisms.

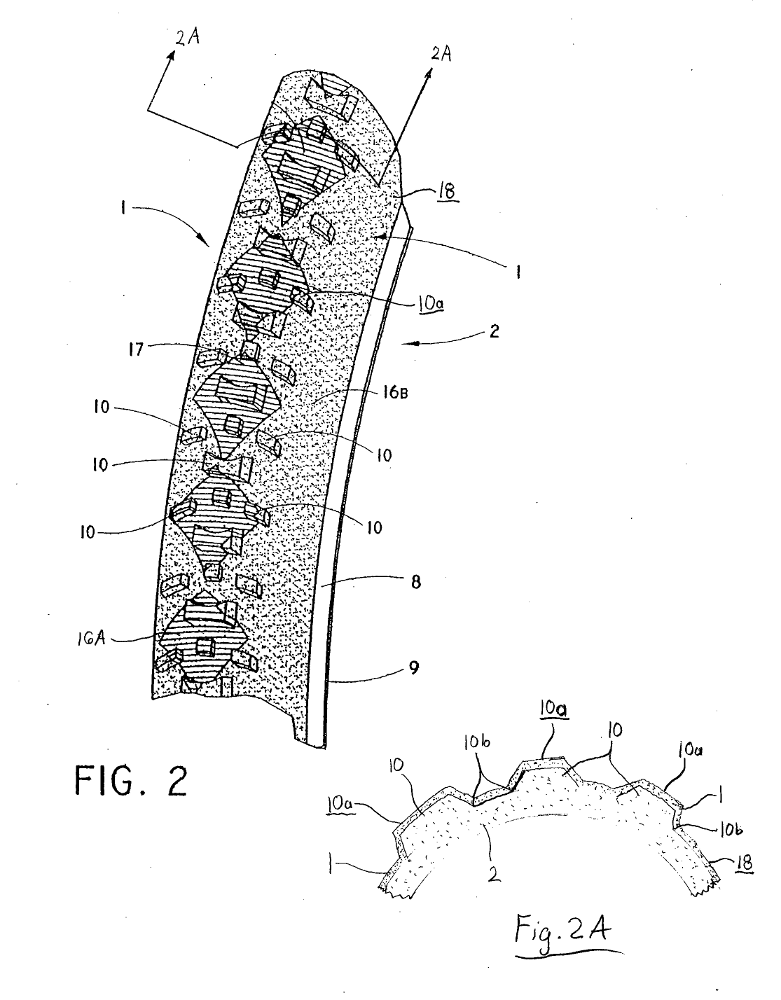

The present invention relates to a base tire or tire 2 having an exo-belt skin or skin 1 that is applied to the external surface of the base tire 2, as is described more fully herein below. The preferred base tire 2 is shown in FIGS. 2, 4 and 5 to illustrate the invention. It should be understood, however, that the skin 1 could be applied to other types of tires including other types of bicycle tires, motorcycle tires, automobile tires, any other circumferential type of tire or any molded polymeric component that may require or it may be desirable to construct with the reinforced skin 1. The skin 1 preferably includes a decorative pattern 16 thereon that enhances the visual interest or appeal of the base tire 2 and the completed tire, in the exemplary embodiments, the bicycle tire. In addition, the skin 1 preferably improves wear and performance of the tire. However, other advantages of having the skin 1 on the tire 2 will hereinafter become apparent to one having ordinary skill in the art.

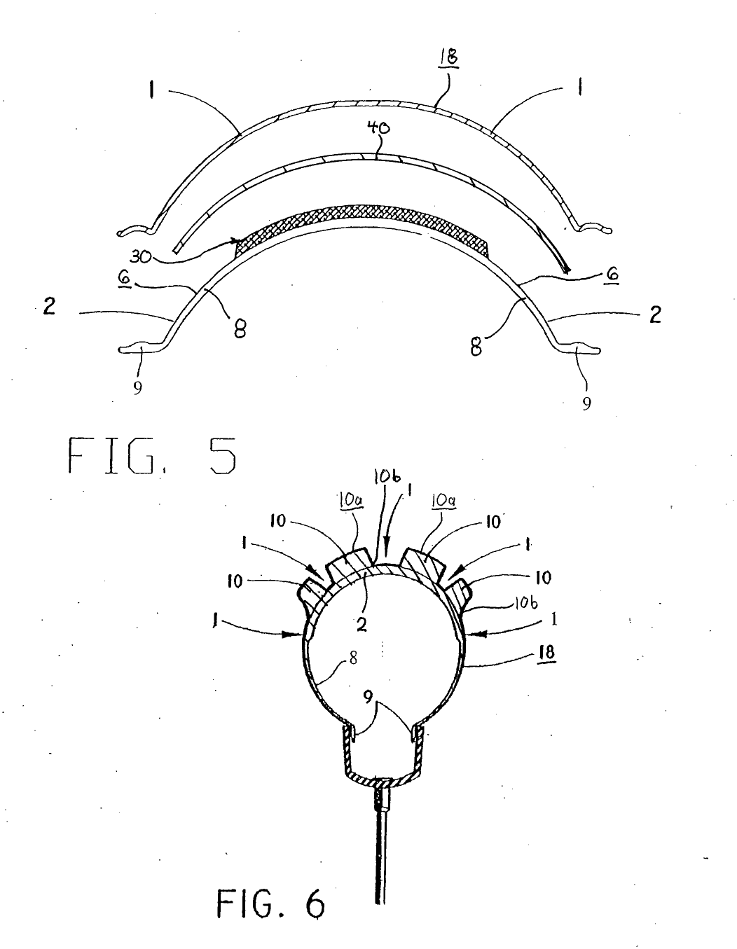

As best shown in FIGS. 5 and 6, the base tire 2 (shown in radial cross-section), which is preferably partially cured, has a circumferential ply or base with an outer circumferential surface 6, a pair of spaced apart annular side walls 8 at the distal ends of the base tire 2, a pair of rim engaging annular beads 9 on the distal ends of the side walls 8 and a tread pattern 30 extending along the outer circumferential surface 6. The tread pattern 30 of the preferred exemplary embodiment includes a plurality of spaced tread members 10, each of which extend radially outwardly from the outer circumferential surface 6 of the base tire 2. The specific tread pattern 30 for a particular tire will vary depending upon the style and type of tire and some tires may not include a tread pattern at all. In addition, the number of plies of the tire or the base tire 2 may vary to include multiple plies such as three (3) ply, four (4) ply, five (5) ply, six (6) ply, etc., depending upon the specific application. Bicycle tires of the type illustrated by FIG. 5 are typically formed utilizing a rubber mixture containing about seventy-five percent (75%) by weight of natural rubber and about twenty-five percent (25%) by weight of synthetic rubber. However, the percentages of the natural rubber and synthetic rubber of the mixture may vary in particular applications.

In addition, in the case of some bicycle tires, reinforcing fibers may be added to the rubber mixture to improve performance. Typically, when such reinforcing fibers are added to the mixture, the mixture is referred to as a “3D compound”. The reinforcing fibers may comprise any suitable fiber or alternative reinforcing material, preferably mono-filament fiber, such as Kevlar®, which may be crushed and mixed into the rubber mixture. Kevlar® is an aromatic polyamide or aramid mono-filament fiber, as is know by one having ordinary skill in the art. Typically, such three dimensional (3D) compounds include approximately three percent (3%) by weight of the reinforcing fibers. However, the percentage of reinforcing fibers in the three dimensional (3D) compound may be less than or greater than three percent (3%) for particular applications.

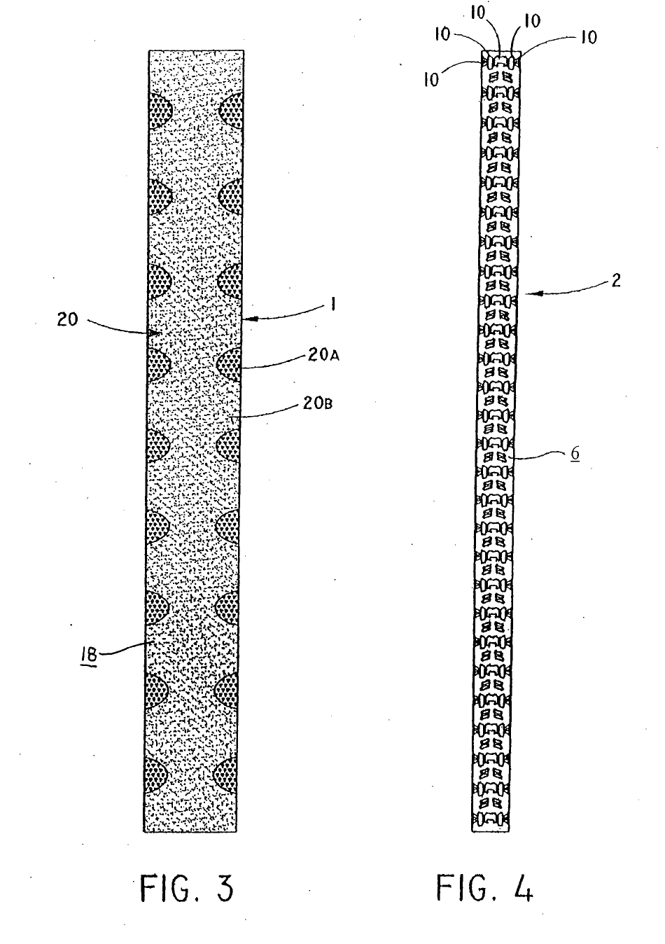

As shown in FIGS. 1-3, 5 and 6, the present invention comprises a skin 1, which is adapted to be permanently installed upon or applied to at least a portion of the outer periphery of a base tire 2. In the preferred embodiment, as best shown in FIG. 3, the skin 1 is generally comprised of an elongated belt or strip which is substantially the same length as the circumferential dimension of the outer circumferential surface 6 of the tire 2. However, the skin 1 could have a length which is greater than or less than the circumference of the outer circumferential surface 6 of the base tire 2. The length will be determined by the aesthetic and performance characteristics one wishes to impart to the bicycle tire through the use of the skin 1. For example, the skin 1 of the preferred embodiment, shown in FIG. 3, wherein the skin 1 is a belt or strip, enhances aesthetic and visual as well as the performance characteristics of the tire around the entire circumference of the base tire 2. In an alternative embodiment, best shown in FIG. 1, the skin 1 is a continuous loop which enhances both the aesthetic and performance characteristics of the entire base tire 2. It is also contemplated that the skin 1 may be for covering only a segment of the base tire 2 to achieve desired characteristics for predetermined zones of the tire.

The skin 1 of the preferred embodiments preferably has a width that encompasses the entire width of the tread pattern 30 and each side wall 8 of the base tire 2 extending from one bead 9 to the other bead 9. That is, it is preferred that the entire exposed outer circumferential surface 6 of the base tire 2 is entirely covered by the skin 1. It is contemplated, however, that the width of the skin 1 may be less than that of the base tire 2 of the preferred embodiment. For example, the skin 1 could be configured to overlie and cover at least a portion of only one of the side walls 8 of the base tire 2 or just the tread members 10. Alternatively, the skin 1 may be configured to cover the entire outer circumferential surface 6 of the base tire 2 except for the tread members 10, such that the tread members 10 retain their natural ornamental appearance. Again, the width of the skin 1 will depend on the visual and performance characteristics one having ordinary skill in the art desires to impart to the tire. Since one of the functions of the skin 1 is decorative, the width of the skin 1 and the portions of the base tire 2 on which the skin 1 is applied will be determined by the visual effect to be created. The decorative function of the skin 1 is discussed in greater detail below.

Additional factors to be considered in determining the length and width of the skin 1 are the added weight and cost of the skin 1, among other factors. Inasmuch as rotational weight, particularly at the outer circumference of the tire, dramatically increases the amount of work required to increase the rotational speed of the tire, minimizing the rotational weight is important to overall tire performance. Accordingly, it is preferred that the skin 1 is tailored to balance between the added tire weight and the aesthetic and performance purposes and visual effect sought to be achieved. Whereas in the preferred embodiments, the skin 1 is intended to enhance the aesthetic characteristics of the tire around the entire outer periphery of the base tire 2, one may desire that the visual aesthetic characteristics are more locally limited on the outer circumferential surface 6 and/or tread members 10 of the tire.

As best shown in FIGS. 1 and 3 the skin 1 preferably has visual characteristics that extend throughout at least some portion of the skin 1. More preferably, the visual characteristics could extend throughout the entire surface of the skin 1. Preferably, the skin 1 extends from the base tire 2 to embrace the entire outer periphery of the tire including the outer circumferential surface 6 and the entire surface of each of the tread members 10. The skin 1 preferably extends the entire length of the tread members 10, including the end portion, so as to completely cover the entire periphery of each tread member 10 once the skin 1 has been applied to the base tire 2.

Preferably, the skin 1 which, before being applied to the base tire 2 is in a green or partially cured state, is made of a composite rubber mixture, preferably a blend of about twenty-five percent (25%) synthetic rubber, such as styrene-butadiene rubber and about seventy-five percent (75%) natural rubber. The composition of the skin 1 is preferably the same as or similar to the composition of the base tire 2 to which the skin 1 is applied. In this manner, bonding between the skin 1 and the base tire 2 is enhanced. Additionally, a combination of rubber and a polymeric material could be used. Other materials known to those skilled in the art could also be used to construct the skin 1 and/or base tire 2, if desired.

In the preferred embodiments, a relatively high percentage of reinforcing fibers are added to the skin 1 to enhance performance and no or a relatively small percentage of reinforcing fibers are added to the base tire 2. Preferably, the reinforcing fibers are of the aromatic polyamide mono-filament type, such as Kevlar® and are crushed and mixed into the rubber mixture. However, the reinforcing fibers are not limited to the aromatic polyamide mono-filament type and may be constructed of nearly any type of reinforcing material, such as fiberglass, carbon, steel or other like materials that provide desired reinforcing properties to the tire. The reinforcing fibers, preferably the aromatic polyamide mono-filament fibers, could comprise between one and twelve percent (1-12%) by weight of the rubber mixture of the base tire 2 and skin 1, however, the reinforcing fibers of the preferred embodiments preferably comprise about six to twelve percent (6-12%) of the mixture of the skin 1 and zero to three percent (0-3%) of the mixture of the base tire 2. The reinforcing material selected preferably provides both durability and light weight to the skin 1 and is such formulated that the skin 1 bonds to the base tire 2 during production. Preferably the skin 1 is limited in thickness to permit effective transfer and retention of the desired decorative pattern 16 or image onto the desired portion of the outer circumferential surface 6 of the base tire 2 and to provide the desired performance characteristics. However, it is also contemplated that the skin 1 may be constructed having a substantial thickness so as to provide a thick protection layer for the base tire 2 from wear and abrasions.

In the preferred embodiments, the aromatic polyamide reinforcing fibers make up approximately nine percent (9%) by weight of the skin 1 and the reinforcing fibers make up approximately three percent (3%) by weight of the base tire 2. Concentrating the reinforcing fibers in the skin 1 improves puncture resistance of the tire, provides stability to the treads 10 and permits the tire to contain a greater tire pressure therein during use when compared to a typical tire having identically formulated base and skin formulations and concentrations of reinforcing fibers.

Tires are typically subjected to their most extreme stresses and impacts at their outermost surfaces due to the highest hoop stresses occurring at the outer surface, the puncture forces being applied to the outer surface during use and typically the highest bending and shear forces being applied at the bases of the treads 10. Accordingly, the ability to provide additional stiffness, strength and/or puncture resistance to the outermost surface of the tire by increasing the percentage by weight of the reinforcing fibers in the skin 1 is desirable because such an application positions the fibers where they are needed most to react the high stresses in these areas. In addition, the ability to concentrate the reinforcing fibers in the outermost surfaces in the skin 1, where they can be utilized to react the high stresses while reducing the percentage by weight of the reinforcing fibers in the base tire 2, generally reduces costs for the relatively expensive reinforcing fibers because the base tire 2 typically comprises a larger overall volume of the tire, thereby reducing the amount of reinforcing fibers required for each tire. Accordingly, concentration of the reinforcing fibers in the skin 1 improves the performance and durability of the tire while reducing the overall costs associated with producing the tire.

Concentration of the reinforcing fibers in the skin 1 of the tire may also improve the ability of the tire to adhere or stick to the road or other surface that the tire is rolling on in use. Specifically, an outer, top surface 10a of the treads 10 is the surface of the tire that is directly in contact with the road surface or other supporting surface during use and is subjected to the greatest amount of wear. In addition, the inclusion of the reinforcing fibers in the rubber mixture of the base tire 2 and the skin 1 tends to decrease the stickyness of the material. That is, the skin 1, having a high percentage by weight of reinforcing fibers, tends to have a lower stickyness to the road surface when compared to the lower percentage of reinforcing fibers by weight base tire 2 that is comprised of only rubber with no reinforcing fibers therein. When the top surface 10a of the treads 10 wears such that the base tire 2 is exposed at the top of the individual treads 10 or, if desired by the user, the skin 1 at the top surface 10a is shaved to expose the base tire 2, the tires typically have a stronger adherence or stickyness to the road surface, which may be desirable for users in some applications. Such a tire construction provides the desired high strength at an outer surface of the tire and particularly at a root edge 10b of the treads 10 by concentrating the high reinforcing fiber percentage skin 1 the areas of the tire that are subjected to the highest stresses and loads. In addition, such a tire construction provides a relatively high stickyness at the surfaces of the tire that are contacting the road surface by exposing the sticky base tire 2 material to the road surface, either through wear of the tops of the treads 10 to expose the base tire 2 or by shaving of the tops of the treads 10. Accordingly, such a tire would typically have the ability to withstand relatively high tire pressures, high stresses in the skin 1, high stresses at the root edge 10b of the treads 10 and high puncture and wear resistance through inclusion of the high percentage or reinforcing fibers in the skin 1 and provide a highly sticky tire by exposing the relatively low or no percentage of reinforcing fibers base tire 2 to the road surface.

In some applications, at least the exposed outer surface of the skin 1 could be coated with a protective coating (not shown) to protect the skin 1 from the effects of wear and abrasion both following manufacture (in transport, etc.) and during use. Preferably the protective coating is urethane, but it is contemplated that the protective coating could be any transparent or translucent, durable, flexible material with sufficient bonding characteristics to adhere to the skin 1 under the conditions of anticipated use and/or manufacturing. Preferably, the protective coating selected also provides protection to the skin 1 from ultraviolet light and the like. The protective coating preferably works together with the high reinforcing fiber percentage skin 1 to enhance wear resistance at the surface of the tire. The protective coating may not be applied to the top surfaces of the treads 10 such that the relatively sticky, low reinforcing fiber percentage base tire 2 is in facing engagement with the road surface during use.

As best shown in FIGS. 1 and 2, the skin 1 preferably includes the decorative pattern 16, which may be a pattern incorporating the trade dress of a particular manufacturer, retailer or the like (not shown) or some other pattern such as a snake skin pattern and/or other natural or non-natural patterns or the like (not shown), as examples. The decorative pattern 16 may comprise virtually any pattern or simply one or more solid colors. To enhance the safety and aesthetic characteristics of the tire, the decorative pattern 16 may include a phosphorescent material 17 applied in a pattern such as stripes as shown in FIG. 2, or as a solid color as shown in FIG. 1. The decorative pattern 16 may also include reflective or retro-reflective particles or beads such as Scotchlite® from 3M to enhance the visual and safety aspects of the tire. It should be understood that the decorative pattern 16 can be incorporated on or into the skin 1 itself or into the protective coating (not shown) or both. The retro-reflective material could be added to the rubber composition of the skin 1 and/or could be applied to the ink used to form the decorative pattern 16 of the skin 1, if the decorative pattern 16 is printed onto the exposed surfaces of the skin 1. The decorative pattern 16 could also include specifically directed advertising related or unrelated to the tire, bicycle (not shown) or the like. Displaying an advertising label or slogan utilizing the decorative patter 16 may be particularly useful for displaying a company mark on a company vehicle, on a public transportation vehicle tire to provide an alternative revenue source or on a military vehicle to enhance camouflage, as examples. The decorative pattern 16 may be comprised of a plurality of discrete decorative patterns 16a, 16b, as shown in FIGS. 1 and 2. The decorative pattern 16 need not be distributed over the entire skin 1, but may be distributed over only a portion of the skin 1. For example, a portion of the decorative pattern 16 could be located only on the portion of the skin 1 that overlies the side walls 8 of the tire 2 or may be located exclusively in the area of the tread pattern 30 of the tire.

The decorative pattern 16 is visible on at least a portion of the peripheral surface of the skin 1, i.e., it is applied to the surface of the skin 1. Preferably, the skin 1 is produced with the intended colored design printed thereon. Alternatively, it is to be understood that the decorative pattern 16 could be embedded within a portion of the skin 1.

The skin 1 may be made by any of several methods well known to those skilled in the art. Most preferably, the skin 1 is made by creating a thin sheet of rubber composition material (not shown) which is partially cured. Preferably, the skin 1 has a thickness in the range of about one-half to about one millimeter (½-1 mm) and more preferably is in the range of one-half to three-quarters of a millimeter (½-¾ mm). Preferably, a membrane (not shown) is applied to one side of the skin 1 to enable the skin 1 to be handled more easily. It should be understood that the use of a membrane for handling is not necessary. The decorative pattern 16 is printed on the skin 1 using any of a number of techniques known to those skilled in the art, but preferably is printed using offset and other known printing techniques which are well-known. Preferably the ink applied to the skin 1 is sufficiently rubberized or flexible to be able to withstand the rigors of tire use, including expansion during inflation and flexure during use, based on the cycle of alternate tension/compressive stresses created on the tire during normal use.

In an alternative embodiment, at least some of the three dimensional tread members 10 are positioned on the outer circumferential surface 6 in a pattern that corresponds in theme or design to the design printed on the skin 1. In a further alternative embodiment, at least some of the tread members 10 are shaped to correspond in theme or design to the design printed on the skin 1. It is contemplated that the tread members 10 may be both shaped and positioned so as to correspond in design or theme to the design printed on the skin 1 and to enhance the overall aesthetic appearance of the tire.

Referring to FIG. 5, the preferred tire also preferably includes an adhesive membrane inhibitor 40 that is mounted between the base tire 2 and the skin 1 during construction and/or assembly. The adhesive membrane inhibitor 40 may be comprised of a sheet of material or may be comprised of a fluid or flowing material that is brushed or otherwise applied to the outer circumferential surface 6 of the base tire 2 or to an inner surface of the skin 1 prior to assembling the skin 1 to the base tire 2. The adhesive membrane inhibitor 40 is preferably located on all surfaces of the base tire 2 or skin 1 where the base tire 2 and skin 1 come into contact during assembly and construction. The adhesive membrane inhibitor 40 preferably provides a layer of material that resists migration of oil, carbon or other like materials between the base tire 2 and the skin 1 and also preferably improves the adhesion between the base tire 2 and the skin 1 during assembly and processing. The adhesive membrane inhibitor 40 is preferred for the tire of the present application, because the migration of oils, carbon or other like materials from the base tire 2 to the skin 1 may have a negative impact upon the decorative pattern 16 on the exposed surfaces of the skin 1. For example, the migration of carbon from the base tire 2 into the skin 1 during manufacturing may darken or otherwise reduce the quality of the decorative pattern 16. The inclusion of the adhesive membrane inhibitor 40 provides a block to such carbon or other materials that may reduce the quality of or otherwise impact the decorative pattern 16 from migrating into the skin 1. Improvement and maintenance of the quality of the decorative pattern 16 is desirable for producing clear and detailed images and/or patterns with the decorative pattern 16.

The skin 1 is preferably applied to the base tire 2 during the tire manufacturing process. As stated above, the skin 1 is in a partially cured, green state at the time it is constructed. The adhesive membrane inhibitor 40 is preferably positioned between the skin 1 and base tire 2 or is brushed or otherwise applied to the inner surface of the skin 1 or to the outer surface of the base tire 2 prior to positioning the base tire 2 relative to the skin 1. Preferably the skin 1 and inhibitor 40 are applied to the base tire 2 when the base tire 2 is also in a green or partially cured state and the base tire 2, inhibitor 40 and skin 1 are thereafter fully cured (vulcanized) together to form an assembled tire. The adhesive membrane inhibitor 40 tends to improve the adhesion of the base tire 2 to the skin 1 prior to and following a curing cycle. The molding equipment used for curing the base tire 2, inhibitor 40 and skin 1 is conventional equipment used during tire manufacture and is generally well known to those skilled in the art. Other equipment and/or methods may be employed to secure the skin 1 to the base tire 2.

Preferably a BOM vertical mold is used to cure and secure the skin 1, inhibitor 40 and base tire 2 to each other, however, other molds such as a toroidal clam-shell molds or the like could be used, if desired. Preferably, the partially cured skin 1, the inhibitor 40 and the partially cured base tire 2 are placed in the mold and thereafter an expandable interior mold bladder (not shown) is expanded using steam or other such pressure to cause the skin 1, the inhibitor 40 and the base tire 2 to expand into the mold with the outer or exposed surface of the skin 1 facing the inner surface of the mold. Further expansion of the mold bladder causes the skin 1 and base tire 2 to conform to the inner surface of the mold thereby creating the desired tire shape, texture and tread pattern. The adhesive membrane inhibitor 40 generally adheres to both the skin 1 and base tire 2 and improves the bond between the base tire 2 and skin 1. The inhibitor 40 also generally limits or prevents migration of oils, carbon and other contents of the base tire 2 into the skin 1. The bladder is retained in place by the pressure for a predetermined time period during which the tire 1, the inhibitor 40 and the skin 2 are fully cured or vulcanized by heat and pressure transmitted to the bladder via steam or other well known methods. Preferably, the outer surface of the mold is also heated in a manner known to those skilled in the art to enhance curing of the combined skin 1, inhibitor 40 and base tire 2 and to prevent insufficient, inconsistent or over curing of the base tire 2, inhibitor 40 and/or skin 1.

Preferably, the skin 1 is initially positioned in the mold so that upon expansion of the mold bladder, the decorative pattern 16 on the skin 1 is in proper registry with the tread pattern 30 imparted to the skin 1 and the base tire 2 by the inner surface of the mold. It will be recognized by those skilled in the art that the skin 1, through the curing process, becomes fused or bonded to the base tire 2 due to the combination of the skin 1, the inhibitor 40 and the base tire 2 and the final curing process. Thus, when the partially cured base tire 2 and the partially cured skin 1 are subjected to the remainder of the curing process to which a tire is normally subjected and which is well known to those skilled in the art, the skin 1 bonds with or becomes part of the base tire 2 with the inhibitor 40 positioned therebetween and generally creating a barrier to migration of undesirable materials between the skin 1 and the base tire 2 and improving the bond. The bonding of the base tire 2 and the skin 1 is enhanced due to the rubber composition of the skin 1 being generally the same as or similar to the rubber composition of the base tire 2. It is also preferred that the skin 1 is applied prior to filly curing the base tire 2 to help avoid a costly double-cure process and to create a permanent bond between the skin 1 and the base tire 2 so that the visual characteristics of the tire remain aligned with or in registry with the base tire 2 in both the circumferential and axial directions. It should be understood, however, that for some applications, the skin 1 may be applied to the base tire 2 after the base tire 2 is fully cured using an adhesive, for example, the inhibitor 40, or some other direct or intermediate bonding agent or process. Specifically, the adhesive membrane inhibitor 40 may be applied to the base tire 2 after it is fully cured and then the skin 1 may be applied over the adhesive membrane inhibitor 40 for full curing of the skin and inhibitor 40 to the base tire 2.

As shown in FIG. 3, the external surface 18 of the skin 1 may include a surface texture 20 for improving adhesion between the skin 1 and the trail and/or road surface(s) to which the skin 1 is exposed when on a completed tire. The surface texture 20 could be imparted by the mold during the curing process or could be created by adding a textured material to the rubber composition of the skin 1. The primary effect of the surface texture 20, which will preferably cover portions of or the entire surface of the tread members 10 as well as lie within the interstitial region between the tread members 10 and the sides of the tread members 10, is to enhance the ability of the tire to grip trail and/or road surfaces, to shed mud, and/or to channel water away from the tire. As shown in FIG. 3, the surface texture 20 may include a plurality of different textures 20a, 20b, or the surface texture 20 may encompass only a single texture (not shown). The surface texture 20 may be made up of virtually any combination of bumps, knobs, depressions, ridges, etc. that will provide a gripping, mud shedding or water channeling characteristic to the skin 1. As will be recognized by those skilled in the art, the surface texture 20 may also serve to enhance the aesthetic characteristics of the tire. Further, the surface texture 20 may work together with the exposed material of the base tire 2 at the top surface 10a of the treads 10, as was described above, to improve adhesion of the tire to the trail and/or road surface. Further, the typical dark or black appearance of the base tire 2 material exposed at the top surface 10a may be incorporated into the overall aesthetic appearance of the tire in conjunction with the decorative pattern 16 and the shape and location of the treads 10.

It is noted that the preferred skin 1 covers the tread members 10 in their entirety, as contrasted to prior techniques for decorating tires, such as that disclosed in U.S. Pat. No. 5,904,794, which is incorporated herein in its entirety by reference. Covering the entire visual surface of the tire with the decorative pattern 16 or the surface texture 20 is advantageous not only for improving the aesthetics of the tire, but also to permit the design to incorporate the tread members 10 into the overall visual appearance of the tire or of the vehicle that the tire is mounted on. Additionally, covering the tread members 10 with the skin 1 can cause the skin 1 to serve as a reinforcing exo-belt which also improves the performance and wear resistance of the tire, particularly if the reinforcing fibers and more particularly is the above-described high percentage by weight of reinforcing fibers have utilized in the formulation of the skin 1. The high percentage by weight of reinforcing fibers in the skin 1 may be particularly effective in reducing shearing and bending failures of the tread members 10 at their root ends. In the preferred embodiments, the percentage by weight of the reinforcing fibers in the skin 1 is relatively high when compared to the reinforcing fibers in the base tire 2 and the reinforced exo-belt formed by the skin 1 improves the performance, puncture resistance and wear resistance of the tire, while also generally reducing material costs in the construction of the tire, because the overall percentage by weight of the generally high cost reinforcing fibers is reduced by concentrating the reinforcing fibers where they are most required, in the peripheral or skin surfaces of the tire, while employing little or no reinforcing fibers in the base tire 2.

It will be appreciated by those skilled in the art that changes could be made to the embodiments described above without departing from the broad inventive concepts thereof. It should also be understood that the above disclosure is directed generally to a bicycle tire for purposes of providing one example of the types of tires or rubber-type components to which the present invention may be applied. It is contemplated that the present invention may be applied to any type of tire or other rubber or polymeric component, including, but not limited to, all types of bicycle tires including sew-ups, tubeless and clincher tires, in addition to motorcycle tires, automobile tires, heavy equipment tires, etc. and bath mats, car floor mats, rubberized flooring, rubber hoses, golf club grips, conveyor belts, sneaker soles, etc. The application of the constructions and methods for the tire of the present invention may be particularly adaptable for automobile racing tires or public transportation vehicles by adapting the particular properties of the tires to user requirements and for the ability to apply advertisements on the tires utilizing the decorative patterns. It is understood, therefore, that this invention is not limited to the particular embodiments disclosed, but is intended to cover all modifications within the spirit and scope of the invention, as defined by the appended claims.

We claim:

1. A tire for mounting to a transport vehicle, the tire comprising:
a base tire; and
a skin including a predetermined pattern mounted thereon, the predetermined pattern being positioned on an external peripheral surface of the skin, the base tire and the skin being constructed of a predetermined rubber composition, the skin including at least about nine percent (9%) by weight of reinforcing fibers and the base tire including less than about three percent (3%) by weight of reinforcing fibers.

2. The tire of claim 1 wherein the skin includes about nine percent (9%) by weight reinforcing fibers and the base tire includes zero percent (0%) by weight of reinforcing fibers.

3. The tire of claim 1 wherein the skin includes about twelve percent (12%) by weight of reinforcing fibers.

4. The tire assembly of claim 1 further comprising:
tread members having a top surface and extending from the external surface of the tire, the skin being shaved from the top surface of the tread members to expose the base tire to a road surface during use.

5. The tire of claim 1 wherein the reinforcing fiber is comprised of an aramid fiber material.

6. The tire of claim 1 wherein the rubber composition of the skin includes a retro-reflective material therein.

7. The tire of claim 1 wherein the predetermined pattern is comprised of an advertisement printed on the skin.

8. The tire of claim 1 wherein a retro-reflective material is added to at least one of one of the predetermined rubber composition of the skin and the predetermined pattern.

9. The tire of claim 1 wherein the predetermined pattern is comprised of a pattern printed on an entire exposed surface of the skin.

10. A tire for mounting to a transportation vehicle comprising:
a base tire constructed of a first rubber mixture, the first rubber mixture including less than about three percent (3%) by weight reinforcing fibers therein; and
a skin constructed of a second rubber mixture, the skin mounted to and covering an entire outer circumferential surface of the base tire, the second rubber mixture including about nine percent (9%) or more reinforcing fibers by weight.

11. The tire of claim 10 further comprising:
a predetermined pattern printed onto an external peripheral surface of the skin.

12. The tire of claim 10 wherein the reinforcing fiber is comprised of an aramid fiber material.

13. The tire of claim 10 wherein the first and second rubber mixtures are comprised of a blend of approximately twenty-five percent (25%) synthetic rubber and approximately seventy-five percent (75%) natural rubber.

14. The tire of claim 10 wherein the synthetic rubber is comprised of a styrene-butadiene rubber.

15. A tire assembly for insertion into a mold for construction of a tire, the tire assembly comprising:
a partially cured base tire;
an adhesive membrane inhibitor being positioned on an outer circumferential surface of the partially cured base tire; and
a partially cured skin including a predetermined pattern printed thereon, the predetermined pattern being positioned on an external peripheral surface of the skin, the partially cured skin being positioned on the adhesive membrane inhibitor, the adhesive membrane inhibitor generally preventing migration of contaminating materials between the base tire and skin during curing.

16. The tire assembly of claim 15 wherein the contaminating materials are comprised of oil and carbon in the base tire.

17. The tire assembly of claim 15 wherein the adhesive membrane inhibitor is positioned on an entire outer circumferential surface of the partially cured base tire and the partially cured skin is positioned on an entire outer surface of the adhesive membrane inhibitor.

18. The tire assembly of claim 15 wherein the predetermined patter is comprised of an advertisement.

19. The tire assembly of claim 15 wherein the partially cured base tire is constructed of a first rubber mixture having zero percent (0%) by weight of reinforcing fiber therein and the partially cured skin is constructed of a second rubber mixture having twelve percent (12%) by weight of reinforcing fiber therein.

20. The tire assembly of claim 19 wherein the partially cured base tire includes a tread pattern having a plurality of individual treads, each of the individual treads including a top surface, the top surfaces of the individual treads being exposed from the partially cured skin and the adhesive membrane inhibitor.

21. A tire assembly for insertion into a tire mold, the tire assembly comprising:
a partially cured base tire; and
a partially cured skin including a predetermined pattern, the predetermined pattern being printed on a portion of an external surface of the skin that forms a side wall of the tire assembly, the partially cured skin being approximately the same size as the partially cured base tire and surrounding and engaging an entire outer surface of the partially cured base tire, the partially cured base tire and the partially cured skin being insertable into the tire mold together, the predetermined pattern being visible on the side wall of the tire assembly.
